(19) United States
(12) Patent Application Publication
(10) Pub. No.: US 2005/0015865 A1
(43) Pub. Date: Jan. 27, 2005

(54) Garment having protection for the bust

(75) Inventors: Aurelie Chaix, Veyrier Du Lac (FR); Amandine Rolland, Annecy (FR)

Correspondence Address: GREENBLUM & BERNSTEIN, P.L.C., 1950 ROLAND CLARKE PLACE, RESTON, VA, 20191, US

(73) Assignee: Salomon S.A., Metz-Tessy (FR)

(21) Appl. No.: 10/634,780

(22) Filed: Aug. 6, 2003

(30) Foreign Application Priority Data
Jul. 22, 2003 (FR) 03 08952

(51) Int. Cl. G21F 3/02

(52) U.S. Cl. 2/456

(57) ABSTRACT

A garment for protecting the upper portion of the body having, on the back and on the shoulders, a yoke made of a material resistant to abrasion.

### CROSS-REFERENCE TO RELATED APPLICATION

This application is based upon French Patent Application No. 03.08952, filed Jul. 22, 2003, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a protective garment for the bust or torso, for use during sporting activities, particularly walking or running, climbing, etc., while wearing a backpack.

2. Description of Background and Relevant Information

Sporting activities such as those aforementioned are practiced on flat or hilly terrain and create specific problems related to wearing backpacks.

Typically, and particularly in hot weather, the protective garment worn is a regular jersey or T-shirt, made of cotton jersey.

Such jerseys protect the back and the shoulders from friction related to the use of a backpack and also protect the upper body against sunrays and, to a certain extent, against wind.

Nevertheless, such garments are subject to substantial wear and tear stresses in the zone of the back and of the shoulders due to the continuous rubbing/friction exerted between the garment and the backpack during use (waling, races, etc.). The wear and tear stresses are increased if the backpack has a substantial load.

As a result, substantial and rapid wear of the jersey occurs in the aforementioned zones of the back and of the shoulders.

Furthermore, because cotton jersey T-shirts are very absorbent, the moisture originating from the perspiration gets stored in the cotton fibers and does not evacuate.

The T-shirt therefore remains wet in the zones of substantial perspiration and proves to be very uncomfortable to wear. The feeling of discomfort further increases at a stopping point when the user is no longer exerting himself/herself and, therefore, has a strong sensation of being wet.

The user often has to replace his/her T-shirt with another dry one to avoid catching a cold.

### SUMMARY OF THE INVENTION

An object of the present invention is to overcome the above-mentioned drawbacks and to propose a garment for protecting the bust or torso that is adapted to the use of a backpack.

Another object of the present invention is to improve the comfort of such a protective garment.

This object is achieved in the garment for protecting the upper portion of the body according to the invention in that it has, on the back and on the shoulders, a yoke made of a material that is resistant to abrasion.

Indeed, the back and the shoulders are the areas of a T-shirt that are the most exposed to abrasion when using a backpack. The garment will therefore be perfectly adapted to the use of a backpack and will wear much slower than a regular T-shirt.

According to a preferred embodiment, the abrasion resistant material is a woven material.

Indeed, woven materials are more resistant to abrasion than jersey materials due to their woven structure.

In the latter case, the abrasion resistant material is extensible along at least one direction so as not to hinder the user's freedom of movement.

### BRIEF DESCRIPTION OF DRAWINGS

The invention will be better understood and other characteristics thereof will become apparent from the following description, with reference to the attached schematic drawings showing, by way of non-limiting example, a preferred embodiment in which:

FIG. 1 is a front view of a protective garment according to the invention; and

FIG. 2 is a rear view of the garment of FIG. 1.

### DETAILED DESCRIPTION OF THE INVENTION

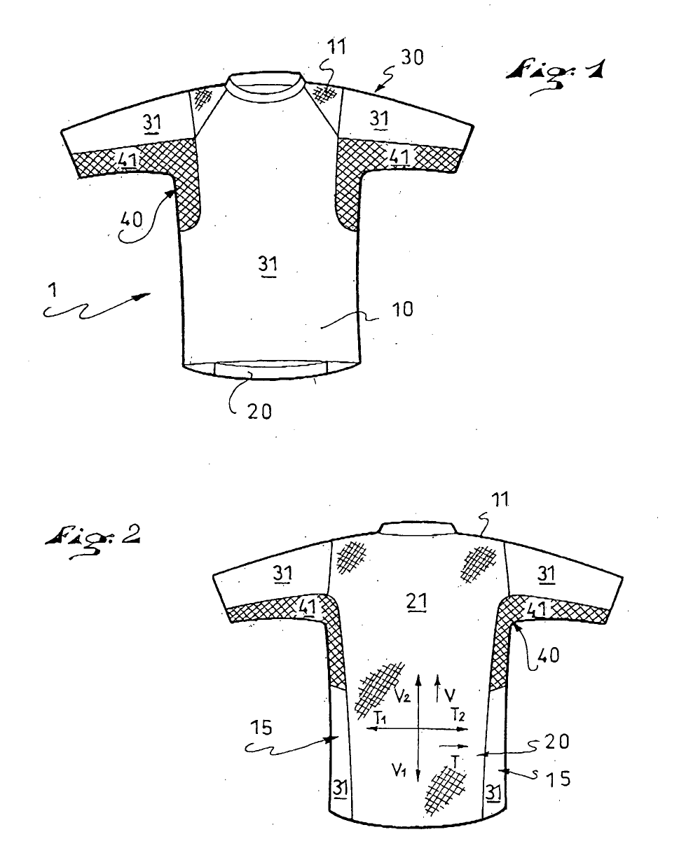

FIGS. 1 and 2 show an example of embodiment of a garment 1 for protecting the upper portion of a body according to the invention, adapted more particularly to sporting activities (walking, hiking, climbing, etc.) while wearing a backpack.

In the present case, the protective garment 1 essentially has the appearance of a T-shirt and has a front portion 10 covering the front of the chest or the upper portion of the body, a rear portion 20 or back covering the rear of the upper portion of the body, and sleeves 30 that, in this case, are short sleeves.

The sleeves 30 could also be of a different length, such as long sleeves.

The garment 1 can also have a form other than the one shown, for example, that of a shirt or a sports blouse/shirt of a long-sleeved jersey, etc.

As shown in the drawing figures, the protective garment 1 first has a yoke 21, 11 covering both the majority of the back 20 and extending up to the front portion of the garment over the shoulder zone 11.

The yoke 21, 11 is made of a single piece or at least without stitches in the shoulder zone that is adapted to cooperate with the straps of the backpack.

This yoke 21, 11 is made of a material that is resistant to the abrasion caused by the continuous rubbing of the backpack, i.e., of the straps and rear thereof, against the garment during use.

According to a preferred embodiment, the yoke 21, 11 is made of a woven material that is more resistant to abrasion and is additionally treated so as to transfer moisture from the inner surface of the yoke to the outer surface thereof. Such a treatment is generally called hydrophile.

The fabric of the yoke 21, 11 is preferably extensible along at least one direction, and preferably along a transverse direction T (see FIG. 2).

It can also be extensible along a single vertical direction V.

However, the fabric will preferably be extensible along both of the V and T directions and, in each case, along the two different courses V1, V2, T1, T2, respectively.

In this manner, depending upon whether the V or T direction or the V1, V2, T1, T2 course is considered, reference will be made to a mono- or bi-extensible fabric or, on the contrary, a fabric extensible along two or four “directions” (understood as “course”).

As an example, the fabric 11, 21 can be a fabric made of 86% of polyester (PES) and 14% of elastane with a density of 140 g/m². Despite its woven structure, such a material 11, 21 will therefore adapt to the user's movements and will be very comfortable to wear.

A yoke 41 is arranged in the axillary zone 40, i.e., the junction zone between the upper end of the sleeve 30 and the associated lateral wall of the chest.

The yoke 41 is a made of a highly aerated material, such as a mesh, i.e., a jersey having a wide mesh defining a highly aerated structure.

Such a material allows for an optimum ventilation due to its highly open and aerated structure.

It is therefore particularly appropriate for placement in the axillary zone that is the zone of maximum perspiration.

The material 41 will preferably undergo an antibacterial treatment and/or will be provided with antibacterial elements, such as silver threads.

Such a material is known, for example, under the trademark “X STATIC.”

The treatment or antibacterial composition prevents bad odors related to the proliferation of bacteria originating from perspiration.

Finally, the remainder of the garment, namely the front panel 10, the top of the sleeves 30, and possibly the lateral portions 15 of the garment, will be made of a material preferably having perspiration draining and evacuation capabilities. Preferably, although in a non-limiting manner, this will be the same material 31.

This material will preferably be a jersey that therefore extensible and which follows the movements of the body, without requiring elastane threads, of the 100% PES type with a density of 135 g/m².

This material has excellent characteristics for drying quickly and hydrophilic properties that enable it to draw moisture quickly towards the outer surface of the fabric and therefore away from the body, and then to dry quickly upon contact with the open air.

One thus obtains, by means of three judiciously arranged materials, a garment for protecting the upper portion of the body which is extremely functional and strong to wear while providing unmatched comfort through its characteristics for eliminating moisture and drying quickly, as well as its antibacterial characteristics and adaptation to movement.

1. A garment for protecting a person's upper body portion, said garment comprising:
a yoke made of a material resistant to abrasion, said yoke being adapted to cover the back and the shoulders of the person's upper body.

2. A garment for protecting the upper portion of the body according to claim 1, wherein the abrasion-resistant material is a woven material.

3. A garment for protecting the upper portion of the body according to claim 1, wherein the abrasion-resistant material is extensible along at least one direction.

4. A garment for protecting the upper portion of the body according to claim 1, wherein the abrasion-resistant material having been treated for transferring moisture from an inner surface of the garment to an outer surface of the garment.

5. A garment for protecting the upper portion of the body according to claim 1, further comprising a highly aerated material in an area of an axillary zone.

6. A garment for protecting the upper portion of the body according to claim 5, wherein the material of the axillary zone has had an antibacterial treatment.

7. A garment for protecting the upper portion of the body according to claim 6, wherein the material of the axillary zone comprises silver threads.

8. A garment for protecting the upper portion of the body according to claim 1, wherein other portions of the garment are made of a material having perspiration draining and evacuation capabilities.
